(19) United States
(12) Patent Application Publication
(10) Pub. No.: US 2011/0102372 A1
(43) Pub. Date: May 5, 2011

(54) Multi-touch and proximate object sensing apparatus using wedge waveguide

(75) Inventors: Jae Joon Han, Seoul (KR); Chang Kyu Choi, Seongnam-si (KR); Kwon Ju Yi, Yongin-si (KR)

(73) Assignee: SAMSUNG ELECTRONICS CO., LTD., Suwon-si (KR)

(21) Appl. No.: 12/662,584

(22) Filed: Apr. 23, 2010

(30) Foreign Application Priority Data
Nov. 5, 2009 (KR) 10-2009-0106373

(51) Int. Cl. G06F 3/042

(52) U.S. Cl. 345/175

(57) ABSTRACT

A multi-touch and proximate object sensing apparatus using a wedge waveguide is provided. A multi-touch and proximate object sensing apparatus may sense a touch location or a target location on a display panel using a light which is reflected by an object located on the display panel. A camera in the multi-touch and proximate object sensing apparatus may sense the touch location or the target location from the light reflected by the object.

### CROSS-REFERENCE TO RELATED APPLICATIONS

This application claims the priority benefit of Korean Patent Application No. 10-2009-0106373, filed on Nov. 5, 2009, in the Korean Intellectual Property Office, the disclosure of which is incorporated herein by reference.

### BACKGROUND

1. Field

Embodiments relate to a sensing apparatus that may sense a touch location or a target location using a wedge waveguide.

2. Description of the Related Art

Along with the development of display technologies, an interest in a technology identifying a location of an object that touches a display has increased. Accordingly, a multi-touch sensing apparatus and method that senses a location of an object that touches a display using an optical sensor has been provided.

Also, a display panel that a user touches may be used in a portable device, and research to reduce a thickness of a multi-touch sensing apparatus has been actively conducted.

### SUMMARY

It is an aspect of one or more embodiments to provide a multi-touch and proximate object sensing apparatus where a camera senses a touch location and a light source to emit a light for sensing the touch location are arranged in an edge of the multi-touch and proximate object sensing apparatus, and thereby may reduce a thickness of the multi-touch and proximate object sensing apparatus.

It is an aspect of one or more embodiments to provide a multi-touch and proximate object sensing apparatus that senses a touch location and a target location using a wedge waveguide, and thereby may improve a sensing sensitivity.

It is an aspect of one or more embodiments to provide a multi-touch and proximate object sensing apparatus, including: a display panel to display an image; a sensing light source to emit a light to sense a touch location or a target location of an object on the display panel indicated by the object, the object being located on or above the display panel; and a camera to sense the touch location or the target location.

The camera and the sensing light source may be arranged on or about an edge of the multi-touch and proximate object sensing apparatus. A portion of light, emitted from the sensing light source, may be reflected by the object, and the camera may sense the touch location or the target location from the light reflected by the object.

The multi-touch and proximate object sensing apparatus may further include a diffuser arranged below the display panel, to transmit the light, emitted from the sensing light source, to the display panel, and to enable the light, reflected by the object, to be focused.

The multi-touch and proximate object sensing apparatus may further include a waveguide arranged below the diffuser to project the light, emitted from the sensing light source, to the diffuser.

The camera may sense the touch location or the target location using the light on the diffuser.

The multi-touch and proximate object sensing apparatus may further include a reflection sheet to be arranged in a lower side of the waveguide, and to reflect the light, reflected by the object, to enable the reflected light to be incident on the waveguide. The camera may sense the touch location or the target location from the light which is incident on the waveguide by the reflection sheet.

The multi-touch and proximate object sensing apparatus may further include a prism sheet to be arranged in an upper side of the waveguide, and to refract the light, reflected by the object, to enable the reflected light to be incident on the waveguide. The camera may sense the touch location or the target location from the light which is incident on the waveguide by the prism sheet.

The sensing light source may emit the light to the object which is spaced apart from an upper side of the display panel, and the camera may sense the touch location or the target location using a light reflected by the object.

It is an aspect of one or more embodiments to provide a multi-touch and proximate object sensing apparatus, including: a display panel to display an image; a sensing light source to emit a light to sense a touch location or a target location of an object on the display panel, the object being located on or above the display panel; a plurality of waveguides on or below the display panel to refract or reflect a light which is reflected by the object; and a camera to sense the touch location or the target location, wherein the camera is arranged on or about an edge of the display panel.

The plurality of waveguides may include: a first waveguide to refract the light reflected by the object; and a second waveguide to reflect the light refracted by the first waveguide.

It is an aspect of one or more embodiments to provide a multi-touch sensing apparatus, including: a display panel to display an image; a waveguide arranged on or below the display panel; a sensing light source to emit a light to sense a touch location of an object on the waveguide, the object being located on or above the waveguide; and a camera to sense the touch location.

It is an aspect of one or more embodiments to provide a method for sensing a touch location or a target location of an object, the method including positioning an object on or above a display panel; emitting light from a sense light source, wherein a portion of the light is reflected by the object; arranging a diffuser below the display panel to transmit light from the sensing light source to the display panel to enable the light reflected from the object to be focused; arranging a waveguide below the diffuser to project the light emitted from the sensing light source to the diffuser; and sensing the touch location or the target location from the light reflected by the object using a camera.

It is an aspect of one or more embodiments to provide a method for sensing a touch location or a target location of an object, the method including: positioning an object on or above a display panel; emitting light from a sense light source; arranging a plurality of waveguides below the display panel to refract or reflect a light which is reflected by the object; and sensing the touch location or the target location from the light reflected by the object using a camera.

### BRIEF DESCRIPTION OF THE DRAWINGS

These and/or other aspects will become apparent and more readily appreciated from the following description of embodiments, taken in conjunction with the accompanying drawings of which:

FIG. 1 illustrates a multi-touch sensing apparatus using reflection of a waveguide according to one or more embodiments;

FIG. 2 illustrates a multi-touch sensing apparatus using refraction of a waveguide according to one or more embodiments;

FIG. 3 illustrates a multi-touch and proximate object sensing apparatus using a plurality of waveguides according to one or more embodiments;

FIG. 4 illustrates a multi-touch and proximate object sensing apparatus using a reflection sheet according to one or more embodiments;

FIG. 5 illustrates a multi-touch and proximate object sensing apparatus using a prism sheet according to one or more embodiments; and

FIG. 6 illustrates a multi-touch and proximate object sensing apparatus using an object on a waveguide according to one or more embodiments.

### DETAILED DESCRIPTION

Reference will now be made in detail to embodiments, examples of which are illustrated in the accompanying drawings, wherein like reference numerals refer to the like elements throughout. Embodiments are described below to explain the present disclosure by referring to the figures.

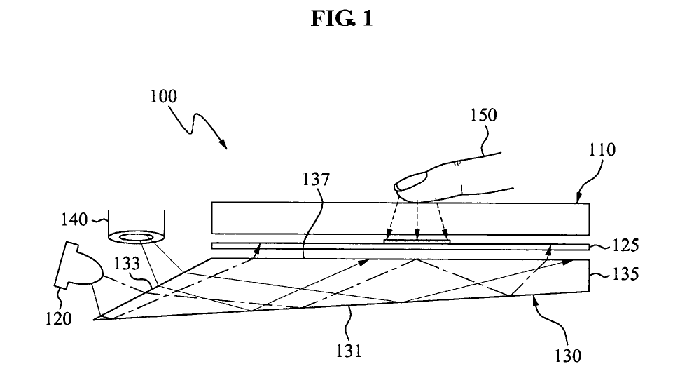

FIG. 1 illustrates a multi-touch sensing apparatus using reflection of a waveguide according to embodiments.

Referring to FIG. 1, the multi-touch sensing apparatus 100 may include a display panel 110, a sensing light source 120, a diffuser 125, a waveguide 130, and a camera 140.

In FIG. 1, the display panel 110 may be arranged on or about a top side of the multi-touch sensing apparatus 100, and display an image. For example, the display panel 110 may be a Liquid Crystal Display (LCD) panel. When the display panel 110 is an LCD panel, since the LCD panel is not self-luminous, the multi-touch sensing apparatus 100 may include a backlight that may provide a light to display the image. The backlight is not illustrated in FIG. 1.

The sensing light source 120 may emit a light to sense a touch image which is displayed on or about a bottom side of on the display panel 110. That is, the sensing light source 120 may emit the light to sense a touch location on the display panel 110. The object 150 may be located on or above the display panel 110. For example, the object 150 may be a finger of a user, a thumb of a user, or a stick (pointer) to touch the display panel 110.

Also, the sensing light source 120 may be arranged close to the camera 140, and emit the light to a sensing region of the camera 140. For example, the sensing light source 120 may be arranged on or about an edge of the multi-touch sensing apparatus 100. Here, an Infrared Ray (IR) may be the sensing light source 120 as an example.

The diffuser 125 may transmit the light emitted from the sensing light source 120. In this instance, the diffuser 125 may enable the light, emitted from the sensing light source 120, to project on the display panel 110.

Also, the diffuser 125 may enable the light, reflected by the object 150, to be focused on the diffuser 125. Accordingly, the camera 140 may sense the touch location of the object 150 through the diffuser 125. For example, a directional diffuser, that may diffuse or transmit light depending on an angle of incident light, may be used as the diffuser 125.

The waveguide 130 may be arranged below the diffuser 125, and project the light, emitted from the sensing light source 120, to the diffuser 125.

Specifically, as illustrated in FIG. 1, as a thickness of the waveguide 130 gradually and regularly decreases, an incidence angle may become greater than a reflection angle for internal reflection. Accordingly, a portion of light, projected to the waveguide 130, may be emitted to an outside of the waveguide 130 to the diffuser 125.

Also, the waveguide 130 may refract and reflect the light, which is reflected by the object 150 and incident on the waveguide 130, through the diffuser 125. That is, a portion of light, emitted from the sensing light source 120, may be reflected by the object 150 and be incident on the diffuser 125 and the waveguide 130.

Specifically, as illustrated in FIG. 1, a bottom side (lower side) 131 of the waveguide 130 may be inclined, and one side 133 of the waveguide 130 may be inclined to the left, where the inclined side 133 and lower side 131 form an acute angle. Here, the inclined side 133 may connect an upper side (top side) 137 and the lower side 131 of the waveguide 130. The waveguide 130 may evenly emit the light, emitted from the sensing light source 120, to the diffuser 125 through the inclined side 133 and the lower side 131. Also, the waveguide 130 may refract and reflect the light which is reflected by the object 150 and incident on the waveguide 130 through the diffuser 125.

The camera 140 may sense a location of the touch image or a target image. Here, the touch image may be generated by the object 150 located on the display panel 110, and the target image may be generated by the object 150 located above the display panel 110.

For example, when a user touches an image displayed on the display panel 110 indicated by the object 150 such as a finger of the user, a thumb of the user or the stick (pointer), the camera 140 may sense the touch location corresponding to the touch image generated by the object 150.

Specifically, the camera 140 may sense the light, refracted and reflected by the waveguide 130, and sense the touch location corresponding to the touch image displayed on the display panel 110. In this instance, the camera 140 may be arranged on or about an edge of the multi-touch sensing apparatus 100, may be configured as a Complementary Metal-Oxide-Semiconductor (CMOS) sensor or a Charge-Coupled Device (CCD) having a lens, and may convert an inputted two-dimensional (2D) image to a digital signal.

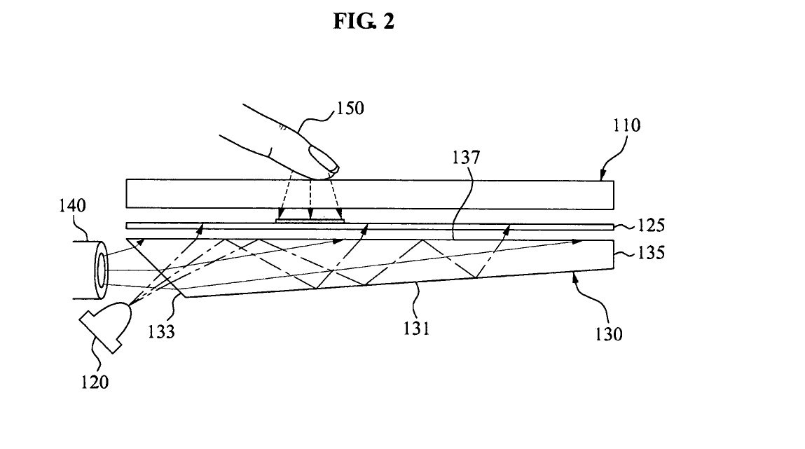

FIG. 2 illustrates a multi-touch sensing apparatus using refraction of a waveguide according to embodiments.

Referring to FIG. 2, the multi-touch sensing apparatus 100 may include the display panel 110, the sensing light source 120, the diffuser 125, the waveguide 130, and the camera 140.

In FIG. 2, the waveguide 130 may be arranged below the diffuser 125. Also, the waveguide 130 may refract a light, reflected by the object 150 and incident on the waveguide 130 through the diffuser 125, without reflection.

Specifically, as illustrated in FIG. 2, a lower side 131 of the waveguide 130 may be inclined, and the inclined side 133 of the waveguide 130 may be inclined to the right, where the inclined side 133 and lower side 131 form an obtuse angle. Here, side 133 may connect an upper side and the lower side 131 of the waveguide 130.

The waveguide 130 may evenly emit the light, emitted from the sensing light source 120, to the diffuser 125 through the lower side 131. Also, the waveguide 130 may reflect the light which is reflected by the object 150 and incident on the waveguide 130. In this instance, the light, reflected by the object 150 and incident on the waveguide 130, may be refracted without reflection.

In FIGS. 1 and 2, the one side 133 may be longer than another end (side) 135, and be arranged close to the camera 140 and the sensing light source 120.

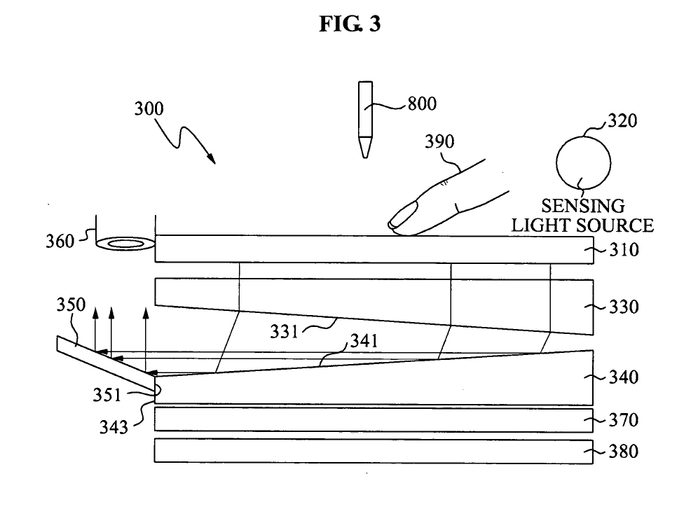

FIG. 3 illustrates a multi-touch and proximate object sensing apparatus 300 using a plurality of waveguides according to embodiments.

Referring to FIG. 3, the multi-touch and proximate object sensing apparatus 300 may include a display panel 310, a sensing light source 320, a first waveguide 330, a second waveguide 340, a reflecting plate 350, a camera 360, a backlight film 370, and a backlight 380.

In FIG. 3, the display panel 310 may be arranged in an upper side of the multi-touch and proximate object sensing apparatus 300, and display an image. When the display panel 310 is an LCD, since the LCD panel is not self-luminous, the multi-touch and proximate object sensing apparatus 300 may include the backlight film 370 and the backlight 380. Since an operation of the display panel 310 is identical to the display panel 110 of FIG. 1, further detailed description is omitted herein.

The sensing light source 320 may emit a light to sense a touch image or a target image displayed on the display panel 310 indicated by objects 390 or an object 800. In this instance, the sensing light source 320 may be arranged outside of the multi-touch and proximate object sensing apparatus 300. For example, an IR may be the sensing light source 320. When the target image is sensed, the sensing light source 320 may emit the light to the object 800.

The first waveguide 330 may refract the light reflected by the objects 390 or the object 800. The objects 390 and 800 may be arranged on or above the display panel 310. That is, the first waveguide 330 may refract the light, reflected by the objects 390 and 800, to the second waveguide 340.

As illustrated in FIG. 3, the first waveguide 330 may be arranged below the display panel 310, and a lower side 331 of the first waveguide 330 may be inclined.

The second waveguide 340 may be arranged below the first waveguide 330 and above the backlight film 370. Also, the second waveguide 340 may reflect the light refracted by the first waveguide 330. In this instance, an upper side 341 of the second waveguide 340 may be inclined, and reflect the light, refracted by the first waveguide 330, to the reflecting plate 350.

The reflecting plate 350 may reflect the light, reflected by the second waveguide 340, to the camera 360. In this instance, as illustrated in FIG. 3, one end (side) 351 of the reflecting plate 350 may be connected to an end (side) 343 of the second waveguide 340. For example, a mirror may be used as the reflecting plate 350.

The camera 360 may sense the light, reflected by the reflecting plate 350, and sense a touch location or a target location. Here, the touch location or the target location may correspond to the touch image or the target image displayed in a bottom side of in the display panel 310 indicated by the objects 390 and 800. The camera 360 may be arranged on or about an edge of the multi-touch and proximate object sensing apparatus 300.

For example, when the touch location is sensed, the camera 360 may sense the touch location corresponding to an image displayed on the display panel 310 indicated by the object 390 such as a finger of the user, thumb of the user, and a stick (pointer).

Also, when the target location is sensed, the camera 360 may sense the target image, corresponding to a location of a reflection light, from among images displayed on the display panel 310. The target image reflection light may be reflected by the object 800 spaced apart from the display panel 310 by a predetermined distance, and have a shape corresponding to a shape of the object 800.

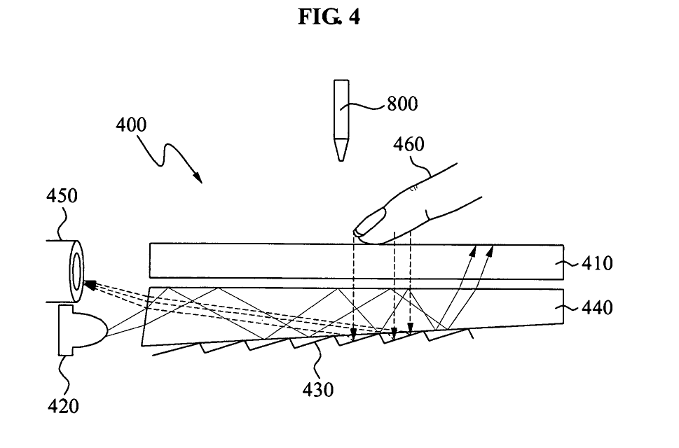

FIG. 4 illustrates a multi-touch and proximate object sensing apparatus 400 using a reflection sheet according to embodiments.

Referring to FIG. 4, the multi-touch and proximate object sensing apparatus 400 may include a display panel 410, a sensing light source 420, a reflection sheet 430, a waveguide 440, and a camera 450. Since the display panel 410 and the sensing light source 420 are identical to the display panel 310 and the sensing light source 320 of FIG. 3, further detailed description is omitted herein.

In FIG. 4, the reflection sheet 430 may be arranged below the waveguide 440. Also, the reflection sheet 430 may reflect a light, reflected by objects 460 or an object 800, to enable the reflected light to be incident on the waveguide 440. For example, the reflection sheet 430 may be a sheet that may reflect light only in an IR band, and be in a wedge shape.

The waveguide 440 may refract the light, reflected by the reflection sheet 430, to the camera 450. Since the waveguide 440 is identical to the waveguide 130 of FIG. 1, further detailed description is omitted herein. In this instance, the waveguide 440 may have a same shape as the waveguide 130 of FIG. 2.

The camera 450 may sense a touch location or a target location from the light reflected by the reflection sheet 430, incident on the waveguide 440, and refracted by the waveguide 440. The touch location or the target location may correspond to a touch image or a target image displayed in a bottom side of in the display panel 410 by the objects 460 and 800. Since the camera 450 is identical to the camera 360 of FIG. 3, further detailed description is omitted herein.

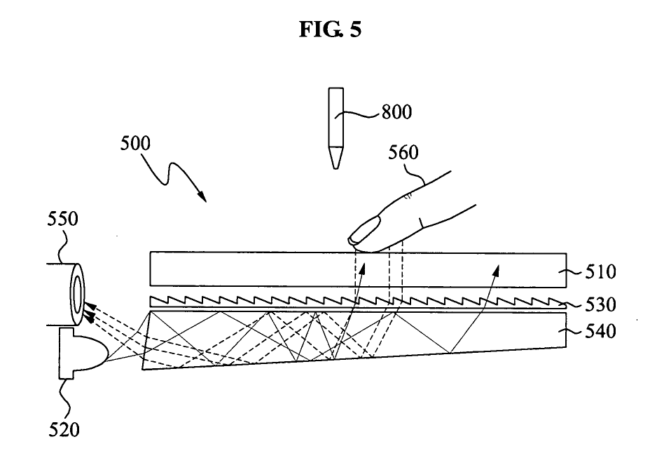

FIG. 5 illustrates a multi-touch and proximate object sensing apparatus 500 using a prism sheet 530 according to embodiments.

Referring to FIG. 5, the multi-touch and proximate object sensing apparatus 500 may include a display panel 510, a sensing light source 520, a prism sheet 530, a waveguide 540, and a camera 550. Since the display panel 510, the sensing light source 520, and the waveguide 540 are identical to the display panel 310, the sensing light source 320, and the waveguides 330 and 340 of FIG. 3, further detailed description is omitted herein. The waveguide 540 may have a same shape as the waveguide 130 of FIG. 2.

In FIG. 5, the prism sheet 530 may be arranged below the display panel 510, and refract a light, reflected by an object 560 or an object 800, to enable the reflected light to be incident on the waveguide 540. Here, the prism sheet may be in a wedge shape.

The waveguide 540 may reflect the light, reflected by the prism sheet 530, to the camera 550.

The camera 550 may sense a touch location or a target location from the light refracted by the prism sheet 530, incident on the waveguide 540, and reflected by the waveguide 540. The touch location or the target location may correspond to a touch image or a target image displayed in a bottom side on the display panel 510 indicated by the objects 560 and 800.

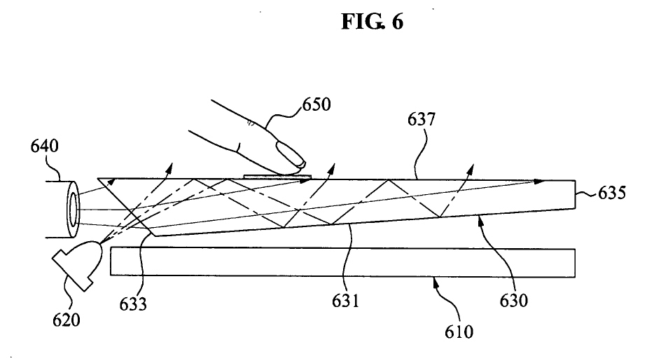

Although it has been described that the waveguide 540 is arranged below the display panel 510 by referring to FIG. 5, a waveguide 630 may be arranged above the display panel 610 as illustrated in FIG. 6. In FIG. 6, reference numeral 631 denotes a lower side (bottom side) of the waveguide 630, reference numeral 633 denotes an inclined side of the waveguide 630, reference numeral 635 denotes another side (end) of the waveguide 630, and reference numeral 637 denotes an upper side (top side) of the waveguide 630. A camera 640 may sense a location corresponding to a touch image, touched by an object 650, on the waveguide 630.

For example, the camera 640 may sense a light refracted and reflected by the waveguide 630, and sense a touch location corresponding to the touch image displayed in a bottom side of in the waveguide 630 indicated by the object 650. In this instance, the camera 640 may be arranged on or about an edge of a multi-touch sensing apparatus 600.

Also, although it has been described that the lower side 131 of the waveguide 130 is inclined in FIGS. 1 and 2, an upper side 137 of the waveguide 130 may be inclined.

Also, a wedge waveguide may be used as the waveguide of the multi-touch sensing apparatus in FIGS. 1 and 2, and as the waveguide of the multi-touch and proximate object sensing apparatus in FIGS. 3, 4, 5, and 6.

Accordingly, a camera senses a touch location and a light source to emit a light for sensing the touch location may be arranged on or about an edge of a multi-touch and proximate object sensing apparatus, and thus a thickness of the multi-touch and proximate object sensing apparatus may be reduced.

Accordingly, a multi-touch and proximate object sensing apparatus may sense a touch location and a target location using a wedge waveguide, and thereby may improve a sensing sensitivity.

Although a few embodiments have been shown and described, it would be appreciated by those skilled in the art that changes may be made in these embodiments without departing from the principles and spirit of the disclosure, the scope of which is defined in the claims and their equivalents.

What is claimed is:

1. A multi-touch and proximate object sensing apparatus, comprising:
a display panel to display an image;
a sensing light source to emit a light to sense a touch location or a target location of an object on the display panel indicated by the object, the object being located on or above the display panel; and
a camera to sense the touch location or the target location,
wherein the camera and the sensing light source are arranged on or about an edge of the multi-touch and proximate object sensing apparatus.

2. The multi-touch and proximate object sensing apparatus of claim 1, wherein a portion of light, emitted from the sensing light source, is reflected by the object, and the camera senses the touch location or the target location from the light reflected by the object.

3. The multi-touch and proximate object sensing apparatus of claim 1, further comprising:
a diffuser arranged below the display panel, to transmit the light, emitted from the sensing light source, to the display panel, and to enable the light, reflected by the object, to be focused; and
a waveguide arranged below the diffuser to project the light, emitted from the sensing light source, to the diffuser.

4. The multi-touch and proximate object sensing apparatus of claim 3, wherein the camera senses the touch location or the target location using the light on the diffuser.

5. The multi-touch and proximate object sensing apparatus of claim 3, wherein one side of the waveguide is inclined, and the waveguide evenly projects the light, emitted from the sensing light source, to the diffuser through the inclined side, the one inclined side connecting an upper side and a lower side of the waveguide, and the inclined side and lower side forming an acute angle.

6. The multi-touch and proximate object sensing apparatus of claim 3, wherein one side of the waveguide is inclined, and the waveguide evenly projects the light, emitted from the sensing light source, to the diffuser through the inclined side, the one inclined side connecting an upper side and a lower side of the waveguide, and the inclined side and lower side forming an obtuse angle.

7. The multi-touch and proximate object sensing apparatus of claim 3, further comprising:
a reflection sheet arranged in a lower side of the waveguide to reflect the light, which is reflected by the object, to enable the reflected light to be incident on the waveguide,
wherein the camera senses the touch location or the target location from the light which is incident on the waveguide by the reflection sheet.

8. The multi-touch and proximate object sensing apparatus of claim 7, wherein the sensing light source is an Infrared Ray (IR), and the reflection sheet reflects the IR.

9. The multi-touch and proximate object sensing apparatus of claim 3, further comprising:
a prism sheet arranged at an upper side of the waveguide, to refract the light, which is reflected by the object, to enable the reflected light to be incident on the waveguide,
wherein the camera senses the touch location or the target location from the light which is incident on the waveguide by the prism sheet.

10. The multi-touch and proximate object sensing apparatus of claim 9, wherein the prism sheet is serrated.

11. The multi-touch and proximate object sensing apparatus of claim 3, wherein the waveguide is a wedge waveguide.

12. The multi-touch and proximate object sensing apparatus of claim 1, wherein the sensing light source emits the light to the object which is spaced apart from an upper side of the display panel, and the camera senses the touch location or the target location using a light reflected by the object.

13. A multi-touch and proximate object sensing apparatus, comprising:
a display panel to display an image;
a sensing light source to emit a light to sense a touch location or a target location of an object on the display panel, the object being located on or above the display panel;
a plurality of waveguides on or below the display panel to refract or reflect a light which is reflected by the object; and
a camera to sense the touch location or the target location,
wherein the camera is arranged on or about an edge of the display panel.

14. The multi-touch and proximate object sensing apparatus of claim 13, wherein the plurality of waveguides comprises:
a first waveguide to refract the light reflected by the object; and
a second waveguide to reflect the light refracted by the first waveguide,
wherein the camera senses the touch location or the target location from the light reflected by the second waveguide.

15. The multi-touch and proximate object sensing apparatus of claim 14, wherein a lower side of the first waveguide is inclined, and an upper side of the second waveguide is inclined.

16. The multi-touch and proximate object sensing apparatus of claim 13, further comprising:
a reflecting plate to reflect the light, which is reflected by the plurality of waveguides, to the camera.

17. The multi-touch and proximate object sensing apparatus of claim 13, wherein the sensing light source is an Infrared Ray (IR) light source which is located outside of the multi-touch and proximate object sensing apparatus.

18. A multi-touch sensing apparatus, comprising:
a display panel to display an image;
a waveguide arranged on or below the display panel;
a sensing light source to emit a light to sense a touch location of an object on the waveguide, the object being located on or above the display panel; and
a camera to sense the touch location.

19. The multi-touch sensing apparatus of claim 18, wherein the camera and the sensing light source are arranged on or about an edge of the multi-touch sensing apparatus.

20. The multi-touch and proximate object sensing apparatus of claim 6, wherein the waveguide refracts light reflected by the object and incident on the waveguide though the diffuser without reflection.

21. A method for sensing a touch location or a target location of an object, the method comprising:
positioning an object on or above a display panel;
emitting light from a sense light source, wherein a portion of the light is reflected by the object;
arranging a diffuser below the display panel to transmit light from the sensing light source to the display panel to enable the light reflected from the object to be focused;
arranging a waveguide below the diffuser to project the light emitted from the sensing light source to the diffuser; and
sensing the touch location or the target location from the light reflected by the object using a camera.

22. The method of claim 21, wherein one side of the waveguide is inclined to the left, and the waveguide evenly projects the light, emitted from the sensing light source, to the diffuser through the inclined side, the one inclined side connecting an upper side and a lower side of the waveguide, and the inclined side and lower side forming an acute angle.

23. The method of claim 21, wherein one side of the waveguide is inclined, and the waveguide evenly projects the light, emitted from the sensing light source, to the diffuser through the inclined side, the one inclined side connecting an upper side and a lower side of the waveguide, and the inclined side and lower side forming an obtuse angle.

24. A method for sensing a touch location or a target location of an object, the method comprising:
positioning an object on or above a display panel;
emitting light from a sense light source;
arranging a plurality of waveguides below the display panel to refract or reflect a light which is reflected by the object; and
sensing the touch location or the target location from the light reflected by the object using a camera.

25. The method of claim 24, wherein the plurality of waveguides comprises:
a first waveguide to refract the light reflected by the object; and
a second waveguide to reflect the light refracted by the first waveguide,
wherein the camera senses the touch location or the target location from the light reflected by the second waveguide.
